(19) United States
(12) Patent Application Publication
(10) Pub. No.: US 2020/0180110 A1
(43) Pub. Date: Jun. 11, 2020

(54) METHOD OF MANUFACTURING IMPELLER BLADE OF SHOT PEENING MACHINE AND IMPELLER BLADE

(71) Applicant: DAEWON APPLIED ENG. CO., Siheung-si (KR)

(72) Inventor: Chan-Ki CHUNG, Incheon (KR)

(73) Assignee: DAEWON APPLIED ENG. CO.

(21) Appl. No.: 16/528,443

(22) Filed: Jul. 31, 2019

(30) Foreign Application Priority Data
Dec. 6, 2018 (KR) 10-2018-0155627

(51) Int. Cl. B24C 3/24; B23P 15/00

(52) U.S. Cl. CPC B24C 3/24; B23P 15/006

(57) ABSTRACT

The present invention relates to a method of manufacturing an impeller blade of a shot peening machine, the method including a part cutting process of forming a shot moving plate in which protrusions are formed by cutting a steel plate and first and second side guide plates in which insertion holes are formed, and a blade assembling process of assembling a blade by inserting the protrusions of the shot moving plate into the insertion holes of the first and second side guide plates, and an impeller blade manufactured according to the method.

### CROSS-REFERENCE TO RELATED APPLICATION

This application claims priority to and the benefit of Korean Patent Application No. 2018-0155627, filed on Dec. 6, 2018, the disclosure of which is incorporated herein by reference in its entirety.

### FIELD OF THE INVENTION

The present invention relates to an impeller blade of a shot peening machine, and more particularly, to a method of manufacturing an impeller blade capable of reducing manufacturing costs and extending a service life of the blade by manufacturing an impeller blade using steel plates, and an impeller blade manufactured through the manufacturing method.

The present invention proposes a method of manufacturing an impeller blade including cutting and machining a steel plate to have an appropriate size to manufacture parts composed of a shot moving plate and first and second side guide plates and assembling the manufactured parts.

### BACKGROUND OF INVENTION

Generally, shot peening machines, which are machines applied to post processes, such as, casting, die casting, and rolling which are production processes of metal products, and an operation of providing compressive residual stresses on metal surfaces, provide compressive residual stresses on surfaces of workpieces by shooting shot balls formed of steel balls and the like at the workpieces to impact the surfaces of the workpieces. The shot peening machines, which shoot the shot balls at the workpieces to machine the surfaces of the workpieces, use methods of shooting the shot balls using compressive air or centrifugal force. The present invention relates to a shot peening machine which supplies shot balls to the center of an impeller rotating at a high speed and shoots the shot balls using a centrifugal force.

A shot peening machine using a centrifugal force supplies shot balls to the center of an impeller and rotates the impeller at a high speed to shoot the shot balls at a workpiece while the shot balls are slid on surfaces of blades mounted on a circumferential surface of the impeller at a high speed due to a high speed centrifugal force to generate a compressive residual stress on a surface of the workpiece. In such a shot peening machine, the impeller is formed to have the plurality of blades which are radially coupled to the impeller between a pair of circular discs which face each other, the impeller is mounted in a case and rotated at a high speed by a motor, the plurality of blades mounted on the impeller are worn and damaged by the shot balls which are shot, the worn and damaged blades should be replaced to continuously operate the machine, and thus the blades of the shot peening machine should be frequently and periodically replaced.

FIGS. 1A-1C are views illustrating a general impeller blade of a centrifugal shot peening machine, and the impeller blade may be manufactured of a steel material or cast iron material. Until now, in a case in which the impeller blade having such a shape is manufactured of a steel material, a cutting operation is complex, it takes a long time to perform a manufacturing process, manufacturing costs are increased, and thus the steel blade is not widely used and a cast iron blade is generally used.

Although manufacturing costs of the iron blade are lower than those of the general steel blade, a service life of the iron blade is shorter than that of the steel blade. In particular, there are problems in that, in a case in which foreign materials such as impurities are included in the cast iron blade during a casting process, a service life can be reduced to half of an average service life or less, and when one blade mounted on a shot peening machine is replaced, all eight blades which are generally mounted on one shot peening machine should be replaced.

In Japanese Patent Application Laid-Open No. 2005-230996, a blade for a shot peening machine is proposed in which a ceramic wear-resistant plate is detachably installed. Although it is presented that a service life of the blade according to this invention is increased by five times a service lifetime or more of a conventional blade formed of a single material so that the service lifetime can range from 600 to 800 hours, a configuration thereof is complex, it is difficult to replace parts thereof, manufacturing costs are high, and thus it is also difficult to apply this invention from a viewpoint of cost-effectiveness.

In Korean Patent Registration No. 585623, an impeller blade is proposed in which a cemented carbide tile which comes into contact with shot balls and a body formed of a synthetic resin or light metal material and mounted on an impeller with the tile therebetween are separately formed. Although such an impeller blade improves durability and extends a service life, since a manufacturing process is complex and manufacturing costs are increased, it is not effective from a viewpoint of cost-effectiveness so that there is a problem in that this invention is not widely applied

In Korean Patent Registration No. 1107603, an impeller blade for a shot peening machine is proposed which has a concave shape in a direction toward a bottom surface of an edge and is formed in a longitudinal direction, and in which a front end of an inner upper surface in the longitudinal direction is rounded and protrudes. In such an impeller blade, although shot balls are moved along a guide surface having a shape in which a center thereof is concave and shot toward a workpiece to increase impact efficiency, a service life cannot be extended, or costs for periodic replacement of the blade cannot be reduced.

In Korean Patent Registration No. 1608926, a shape of a blade (see FIG. 1B) is proposed in which a fixing hole of a rotating wheel and a control hole into which a fixing pin is inserted are formed. In a structure of the impeller blade having such a shape, although a damaged and worn blade is quickly and easily replaced, a service life cannot be increased or costs for periodic replacement of the blade cannot be reduced.

In U.S. Pat. No. 9,770,806, an invention of a drum type shot peening apparatus is disclosed which can reduce an operation time for shot and introduces various shapes of a blade for reducing the operation time for shot but is not related to material properties, a service life, or reduction of manufacturing costs.

### SUMMARY OF THE INVENTION

The present invention is directed to manufacturing an impeller blade having significantly reduced manufacturing costs in comparison with those of a cast iron blade by using a steel material to manufacture an impeller blade of a shot peening machine. In addition, the present invention is directed to simplifying the shape and structure of an impeller blade and easily replacing the blade.

However, objectives of the present are not limited thereto, and other objectives according to the following means or specific configurations according to embodiments may be clearly understood by those skilled in the art from the following description even though they are not described.

According to an aspect of the present invention, there is provided a method of manufacturing an impeller blade of a shot peening machine, the method including a part cutting process of forming a shot moving plate in which protrusions are formed by cutting a steel plate and first and second side guide plates in which insertion holes are formed, and a blade assembling process of assembling a blade by inserting the protrusions of the shot moving plate into the insertion holes of the first and second side guide plates.

The present invention may include a part heat treatment process of quenching the formed shot moving plate and first and second side guide plates at a temperature which is higher than an A3 transformation point by 30 to 50° C. and tempering the shot moving plate and the first and second side guide plates at a temperature which is less than or equal to an A1 transformation point.

A material of the steel plate which is used according to the present invention may be high carbon steel or high manganese steel, and the present invention may further include a bending process of bending the shot moving plate or a part grinding process after the part cutting process.

A fixing protrusion or a fixing groove may be formed in each of the first and second side guide plates according to the present invention.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIGS. 1A and 1B are perspective views of general conventional blades mounted on impellers of shot peening machines, and FIG. 1C is a view illustrating a coupling structure between an impeller and blades of a shot peening machine according to a conventional method;

FIG. 2 is a perspective view illustrating a state in which a blade according an embodiment of the present invention is being mounted on an impeller;

FIGS. 3A-3B are perspective views illustrating states in which the blade of FIG. 2 is disassembled and assembled;

FIG. 4 is a view illustrating a state in which a blade according to anther embodiment of the present invention is being mounted on an impeller;

FIGS. 5A-5B are perspective views illustrating states in which the blade of FIG. 4 is disassembled and assembled;

FIG. 6 is a perspective view illustrating a state in which a blade according to still anther embodiment of the present invention is being mounted on an impeller;

FIGS. 7A-7B are perspective views illustrating states in which the blade of FIG. 6 is disassembled and assembled; and

FIG. 8 is a process diagram showing a manufacturing process of the blade of the present invention.

### DETAILED DESCRIPTION OF PRESENT INVENTION

Hereinafter, embodiments of the present invention will be described with reference to the accompanying drawings. The following descriptions will be made focusing on portions necessary to understand operations and actions according to the present invention. While the embodiments of the present invention are described, descriptions of technical contents which are well-known in the art and are not directly related to the present invention will be omitted. This is to more clearly provide the gist of the present invention without obscuring the gist by omitting unnecessary descriptions.

In addition, in descriptions of components of the present invention, a different reference numeral may be assigned to the same component depending on the drawings, and the same reference numeral may be assigned to the same component in different drawings. However, this does not mean that the component has a different function depending on embodiments or that the component has the same function in different embodiments. Functions of each component may be determined based on descriptions of each component in the corresponding embodiment.

In addition, unless otherwise defined, all technical terms used herein should be interpreted to have customary meanings to those skilled in the art to which this invention belongs, and should not be interpreted with overly idealized or reduced meanings.

In addition, the singular forms “a,” “an,” and “the” used in the present specification are intended to include the plural forms as well, unless the context clearly indicates otherwise. It should be interpreted that the terms “comprises,” “comprising,” “includes,” and/or “including,” when used herein, specify the presence of stated components or various operations thereof, may not include some components and operations therein, or may further include additional components and operations.

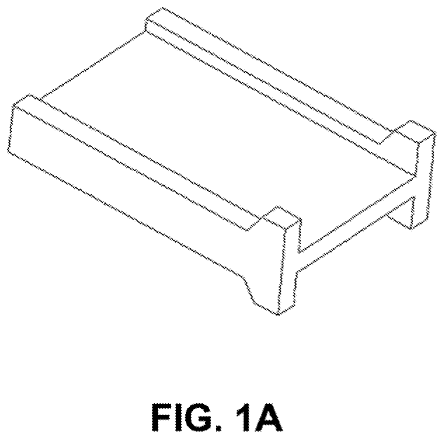

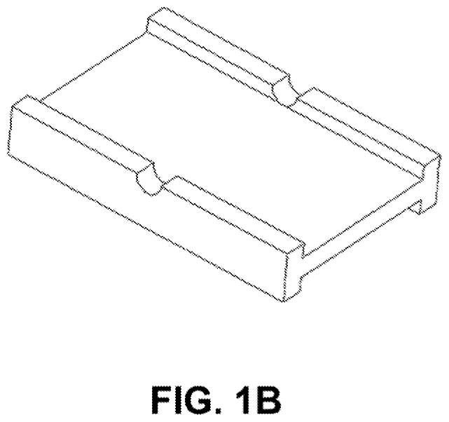

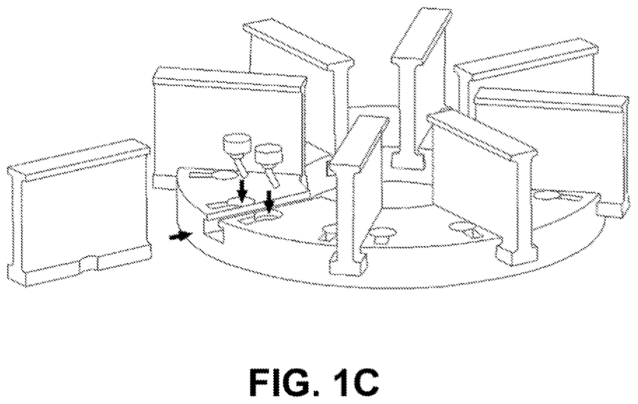

General impeller blades are formed as illustrated in FIGS. 1A-1C, and when the impeller blades are inserted to be mounted between discs of both sides of an impeller of a shot peening machine that shoots shot balls using a centrifugal force, the shot balls are supplied to a center portion of the impeller, moved to the blades, and shot at a workpiece from the blades, and thus a surface treatment operation of the workpiece is performed while the impeller is rotated.

A blade that shoots shot balls according to the present invention includes a shot moving plate and first and second side guide plates at both sides of the shot moving plate, and such parts are individually manufactured and assembled into the blade so that manufacturing of an impeller blade is completed.

When the blade manufactured according to the present invention is mounted on the impeller of a shot peening machine, the shot balls are supplied to the shot moving plate of the blade, a centrifugal force is applied to the shot balls due to rotation of the impeller, and the shot balls are moved along a bottom surface of the shot moving plate in an outer circumferential direction of the impeller and shot at a workpiece.

Two discs assembled to stand on opposite sides such that the blade is fitted prevent the shot balls from being shot in a lateral direction from the shot moving plate of the blade when the shot balls are shot at the workpiece, the first and second side guide plates assembled with the shot moving plate are inserted into blade fixing grooves formed in the discs, and the blade is not separated from the impeller and is fixed thereto due to fixing grooves formed in the first and second side guide plates or fixing protrusions when the impeller is rotated.

The shot moving plate and the first and second side guide plates of the blade according to the embodiment of the present invention are formed to have structures in which final shapes are formed only by cutting thin steel plates.

The shot moving plate of the blade of the present invention is manufactured by forming protrusions on side surfaces of a plank having a rectangular shape and a predetermined thickness, and each of the first and second side guide plates are manufactured to have a rectangular shape which has a length equal to that of the shot moving plate, a predetermined thickness, and a narrow width, and in which an insertion hole is formed in a center portion thereof in a width direction.

The protrusions of the shot moving plate and the insertion holes of the first and second side guide plates have the same shape to be fitted to each other and may be manufactured to have a quadrilateral shape.

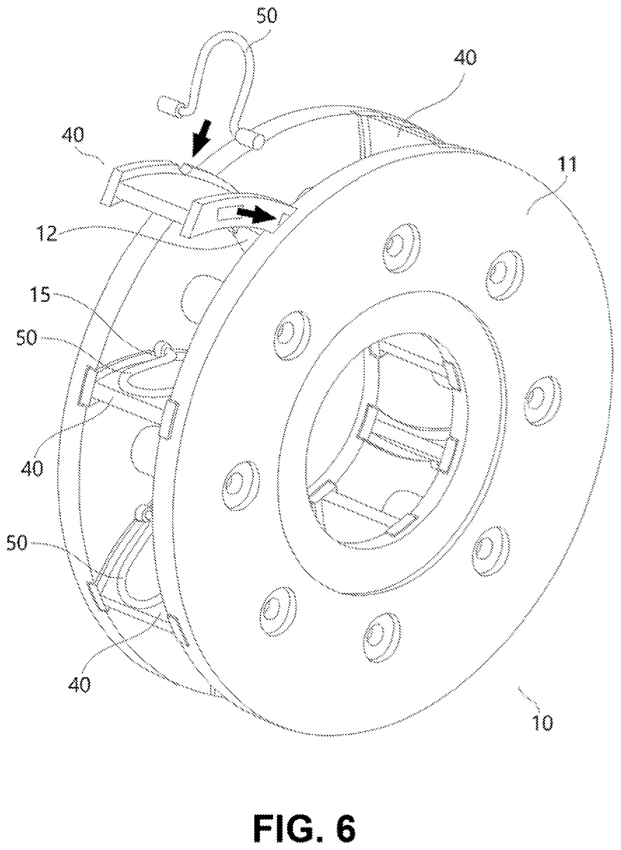

A shot moving plate or first and second side guide plates manufactured according to another embodiment of the present invention may be manufactured to have curved or bent shapes as illustrated in FIG. 6 by a heating and bending operation after a steel plate cutting process.

The shot moving plate manufactured to have the curved or bent shape may be manufactured by cutting the shot moving plate to have a concave groove shape or curved shape at a center portion in a longitudinal direction thereof or a center portion in a direction perpendicular to the longitudinal direction, but in a case in which the shot moving plate is manufactured as described above, a thick steel plate should be used, an amount of material loss and a machining time are increased, and thus it is not preferable from a viewpoint of cost-effectiveness.

Only high carbon steel or high manganese steel may be used for a steel plate for manufacturing the blade according to the embodiment of the present invention from a viewpoint of manufacturing cost-effectiveness. When the high carbon steel or the high manganese steel is used, machining costs may be increased, but a service life may be significantly extended, and thus it is effective from a viewpoint of cost-effectiveness.

In addition, a steel plate having a predetermined thickness may be used to manufacture the blade according to the embodiment of the present invention, and the shot moving plate and the first and second side guide plates may be manufactured using steel plates having the same thickness. Since the shot moving plate and the first and second side guide plates are manufactured using the steel plates having the same thickness, generation of waste material is prevented, and efficiency of material management can be improved, a machining process can be simplified, and thus manufacturing costs can be reduced.

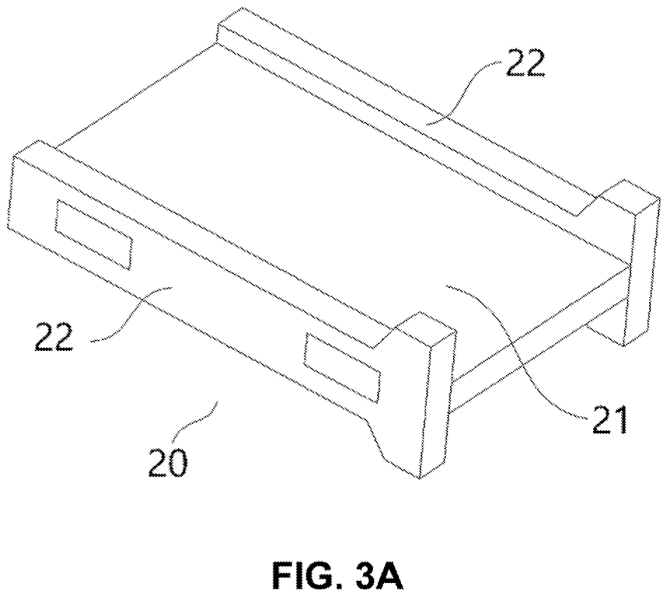

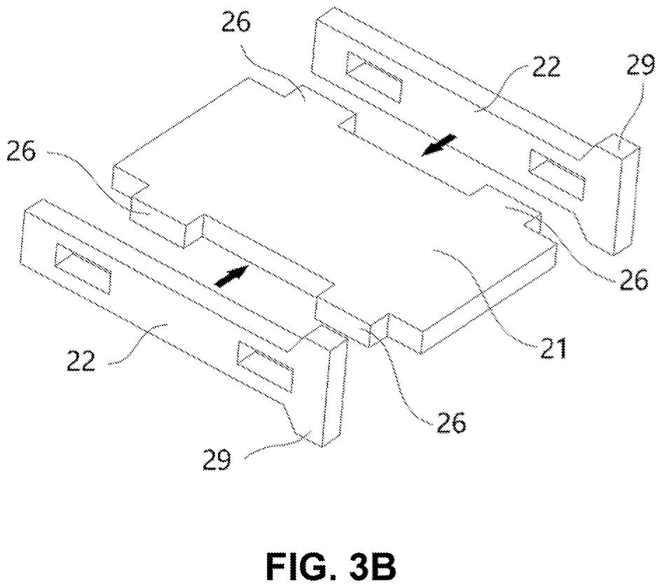

As illustrated in FIGS. 3A-3B, since a shot moving plate (21) manufactured according to one embodiment of the present invention is formed by cutting a steel plate, the shot moving plate (21) has a rectangular shape which has a thickness equal to that of the used steel plate and has one or more protrusions (26) in which portions of both side surfaces of the shot moving plate (21) protrude outward.

First and second side guide plates (22) are also manufactured by cutting a steel plate, fixing protrusions (29) are formed in which end portions of one sides of the first and second side guide plates (22) extend in a longitudinal direction and protrude from the steel plate having a rectangular shape of a small width, and a length equal to that of the shot moving plate (21), and insertion holes (27) are formed in center portions in a width direction of the first and second side guide plates (22) at positions corresponding to the protrusions (26) of the shot moving plate (21).

In the shot moving plate (21) and the first and second side guide plates (22) in which a cutting process, a surface treatment machining, and a heat treatment process are performed, the protrusions (26) of the shot moving plate (21) are inserted into the insertion holes (27) of the first and second side guide plates (22) to join the shot moving plate (21) to first and second side guide plates (22) and thus an impeller blade (20) according to the embodiment of the present invention is formed.

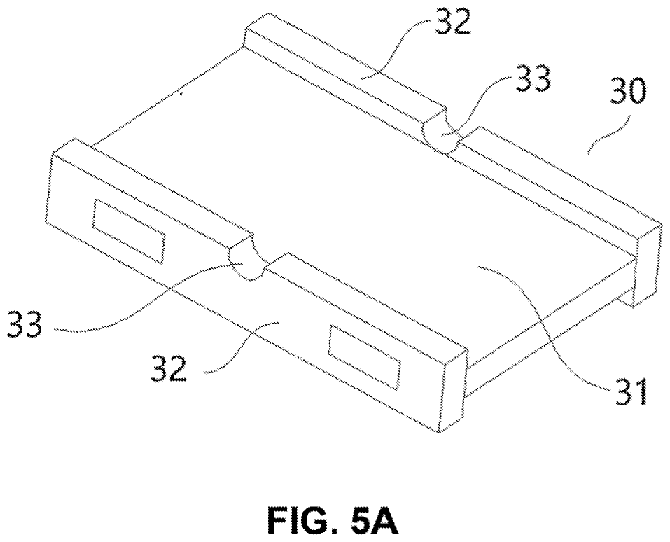

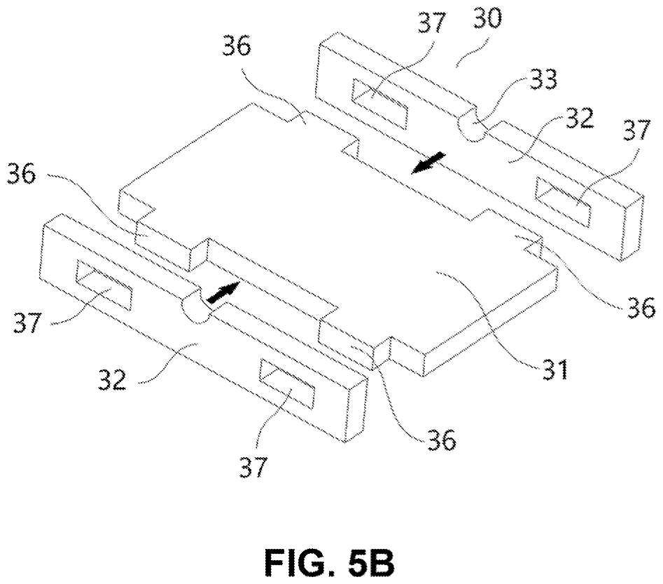

According to one embodiment of the present invention, the protrusions (26) of the shot moving plate (21) have a cross section in a quadrilateral shape, two protrusions (26) are formed on each of the both sides of the shot moving plate (21), and two insertion holes (27) are formed to have a quadrilateral shape in each of the first and second side guide plates (22). As illustrated in FIGS. 5A-5B, fixing grooves (33) are formed in longitudinal center portions of first and second side guide plates (32), and two insertion holes (37) are formed such that one insertion hole (37) is formed between the fixing groove and each of both ends of the first and second side guide plates (32).

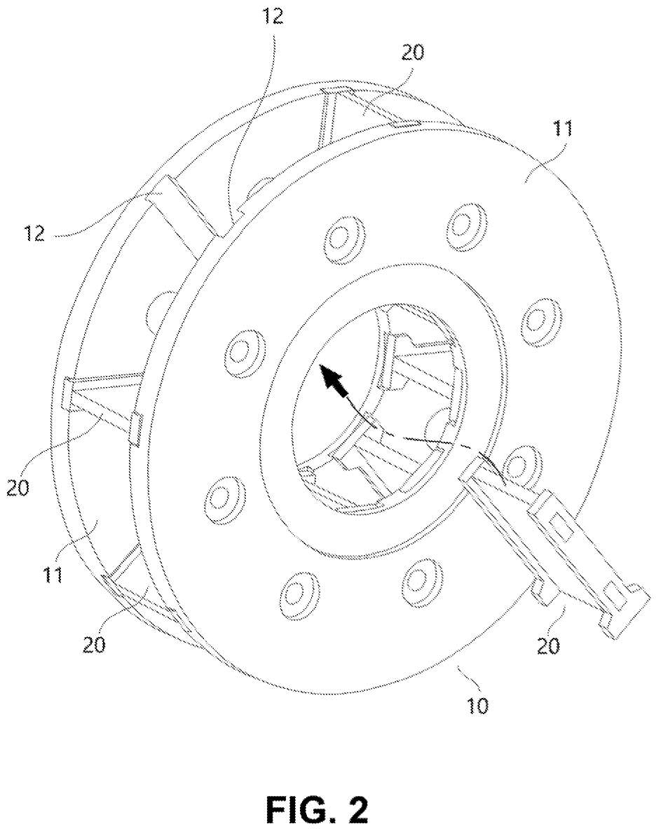

As the impeller blade manufactured according to the embodiment of the present invention is mounted on the impeller of the shot peening machine, the blade of which a service life has been reached may be replaced, the impeller (10) of the shot peening machine has a structure in which the blade may be inserted and mounted between two discs (11) which face each other as illustrated in FIG. 2, and the fixing protrusions (29) of the first and second side guide plates (22) of the blade (20) are fixedly inserted into blade fixing grooves (12) formed in inner surfaces of the discs (11) which face each other so that the blade (20) is mounted on the impeller (10).

When the impeller (10) of the shot peening machine, in which the blade is mounted, is rotated, shot balls supplied to a center portion thereof are moved to the blade and shot at a workpiece, and thus a surface treatment is performed on the workpiece.

A blade (30) according to another embodiment of the present invention may be manufactured as illustrated in FIGS. 5A-5B. A shot moving plate (31) is formed to have a shape which is the same as that of the shot moving plate (21) according to the embodiment of FIGS. 3A-3B, and insertion holes (37) of first and second side guide plates (32) are also formed to have a shape which is the same as that of the insertion holes (27) of the first and second side guide plates (22) according to the embodiment of FIGS. 3A-3B, but, since portions having a shape which is identical or similar to that of the fixing protrusion (29) are not formed, the first and second side guide plates (32) are formed to have a rectangular shape, fixing grooves (33) are formed, which are concavely recessed from center portions of upper or lower surfaces of the first and second side guide plates (32), and fixing pin fixing grooves (15) are formed in blade fixing grooves (12) of discs (11) disposed to face each other on both sides of the impeller (10) at positions corresponding to the fixing grooves (33) when the discs (11) are coupled to the blade (30).

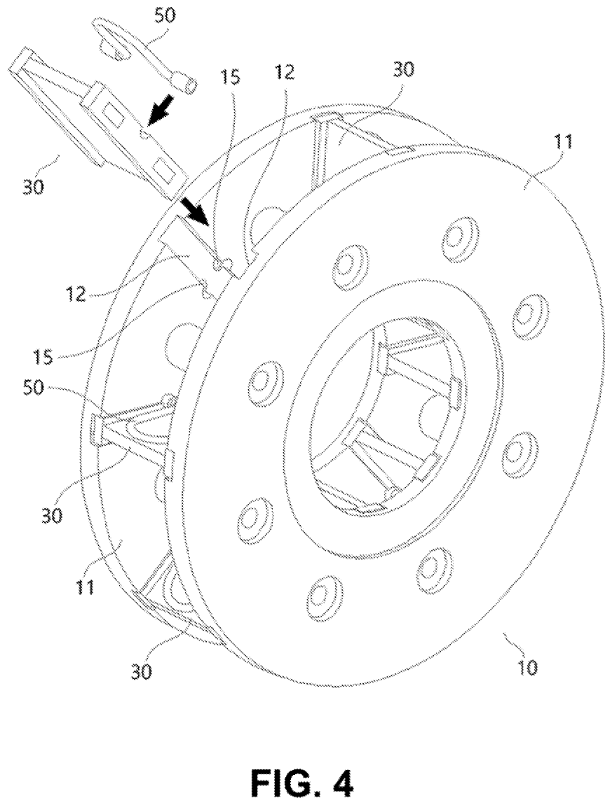

As illustrated in FIG. 4, the impeller blade (30) manufactured according to the embodiment of FIGS. 5A-5B is mounted on the impeller (10) of the shot peening machine, the first and second side guide plates (32) of both sides of the blade (30) are inserted into the blade fixing grooves (12) formed in inner surfaces of the both of the discs (11) of the both sides of the impeller, and a fixing pin (50) is inserted into the fixing grooves (33) of the blade (30) and the fixing pin fixing grooves (15) of the discs (11) to fix the blade (30) to the impeller (10).

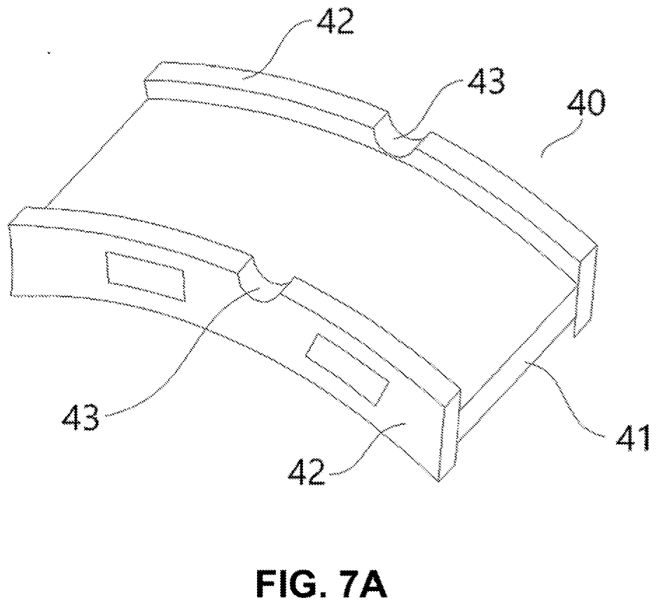

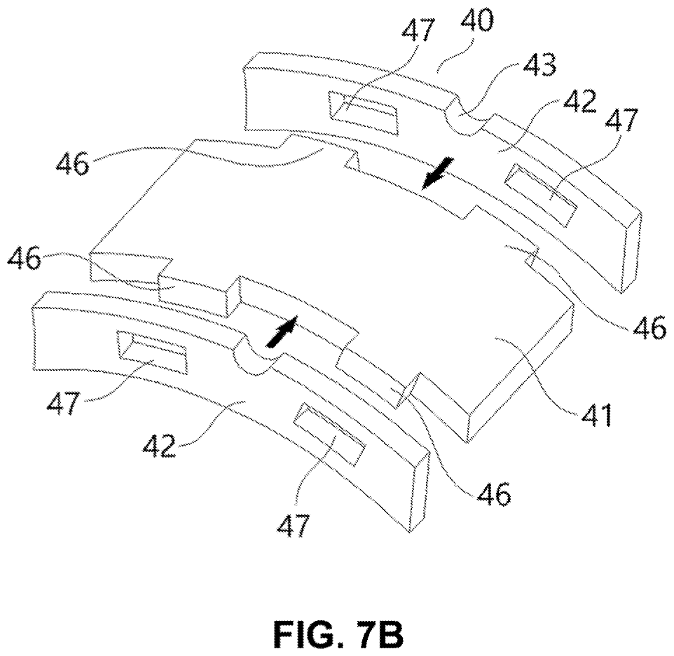

As illustrated in FIGS. 7A-7B, a blade (40) according to still another embodiment of the present invention may be manufactured. A shot moving plate (41) and first and second side guide plates (42) are similar to the shot moving plate (31) and the first and second side guide plates (32) according to the embodiment of FIGS. 5A-5B, but there is a difference in shape in that the shot moving plate (41) and the first and second side guide plates (42) have curved or bent shapes.

A direction in which the shot moving plate (41) and the first and second side guide plates (42) are curved or bent is a direction perpendicular to a longitudinal direction in which shot balls are moved along the shot moving plate (41), and when the blade (40) is mounted on an impeller (10), since the blade (40) is curved in a circumferential direction in which the impeller (10) is rotated, a shot speed of shot balls can be increased.

As illustrated in FIG. 6, the blade (40) manufactured according to the embodiment of FIGS. 7A-7B may be mounted on the impeller (10) of the shot peening machine and is mounted through a method which is the same as the mounting method illustrated according to the embodiment of FIG. 4.

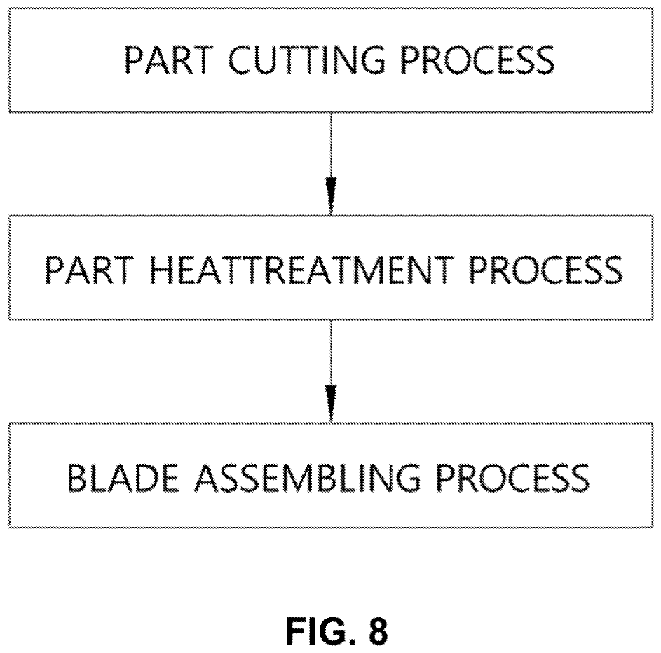

In the manufacturing process of the impeller blade according to the present invention, the impeller blade is manufactured in the order of (a) a part cutting process, (b) a part heat treatment process, and (c) a blade assembling process according to a process sequence illustrated in FIG. 8.

(a) Part Cutting Process

A shot moving plate and first and second side guide plates are formed by cutting a steel plate. The cutting may be performed through a method of cutting using a method such as a laser machining method and a wire electric discharge machining method, and it is efficient to use the laser machining method. By using laser machining, exteriors of the shot moving plate and the first and second side guide plates are formed, and formation of protrusions (26 or 36) of the shot moving plates (21 or 31) and insertion holes (27 or 37) of the first and second side guide plates (22 or 32) can be facilitated.

When finishing surface treatments of the formed parts are required according to used materials and a working environment of the cutting, a surface treatment may be performed using a grinding wheel.

A bottom surface of the shot moving plate (41) formed as illustrated in FIGS. 7A-7B may be curved or bent through a post-heating bending process, and the formed first and second side guide plates (42) may also be curved to match the curved shape of the shot moving plate (41) through a post-heating bending process. A center portion of the shot moving plate (41) in a longitudinal direction, in which shot balls are moved, may be curved outward.

Each of the first and second side guide plates (42) may also have a height and a width which are large enough to maintain a quadrilateral shape and to cover an entire side surface of the curved shot moving plate (41), but the post-heating bending process may be performed on the first and second side guide plates, which are cut and machined to have the quadrilateral shape, so as to match the curved shape of the shot moving plate (41) as illustrated in FIGS. 7A-7B.

(b) Part Heat Treatment Process

Manufacturing of blade parts is completed by quenching the shot moving plate and the first and second side guide plates manufactured using steel plates through the cutting process at a temperature which is higher than an A3 transformation point by 30 to 50° C. and tempering the shot moving plate and the first and second side guide plates at a temperature which is lower than or equal to an A1 transformation point or less.

(c) Blade Assembling Process

The protrusions (26, 36 or 46) of the shot moving plate are inserted into the insertion holes (27, 37, or 47) of the first and second side guide plates to fixedly couple the shot moving plate (21, 31, or 41) to the first and second side guide plates (22, 32, or 42) so that formation of the impeller blade (20, 30, or 40) is completed.

Since the impeller blade manufactured according to the present invention is formed of a steel material, a service life can be increased, a uniform quality level can be maintained, and manufacturing costs can also be significantly reduced in comparison with manufacturing costs of a cast iron blade.

In addition, since the blade is formed to be separated into the shot moving plate and the first and second side guide plates, convenience can be improved when the blade is mounted on the impeller, and in a case in which a service life of the shot moving plate has been reached, only the spent shot moving plate can be replaced while the first and second side guide plates are still used.

The present invention can increase a service life of a blade in comparison with that of a cast iron blade and can significantly reduce manufacturing costs of the blade in comparison with those of the cast iron blade. In addition, since a shot moving plate and first and second side guide plates are separately formed to form the blade, and the blade is used in which the shot moving plate and the first and second side guide plates are assembled, replacement convenience of the blade is improved, and the shot moving plate and the first and second side guide plates can be selectively replaced.

Although the embodiments of the present invention have been described with reference to the above contents, it will be understood by those skilled in the art that the invention may be performed in other specific forms without changing the technological scope or essential features.

Therefore, the above-described embodiments should be considered in a descriptive sense only and not for purposes of limitation, and the scope of the present invention is defined by the appended claims and encompasses all modifications or alterations derived from meanings and the scope of the appended claims, and equivalents thereof.

What is claimed is:

1. A method of manufacturing an impeller blade of a shot peening machine, the method comprising:
a part cutting process of producing a shot moving plate and first and second side guide plates by cutting steel plates using a laser machining method or a wire electric discharge machining method, wherein materials of the steel plates are high carbon steel or high manganese steel, a fixing groove is formed in each of the first and second side guide plates, two insertion holes are formed between the fixing groove and both ends of each of the first and second side guide plates, and two protrusions are formed on each of both sides of the shot moving plate;
a part heat treatment process of quenching the formed shot moving plate and first and second side guide plates at a temperature which is higher than an A3 transformation point by 30 to 50° C. and tempering the shot moving plate and the first and second side guide plates at a temperature which is less than or equal to an A1 transformation point; and
a blade assembling process of assembling the first and second side guide plates to both side surfaces of the shot moving plate by inserting the protrusions of the shot moving plate into the insertion holes of the first and second side guide plates,
wherein the fixing groove is formed to be concavely recessed in a longitudinal center portion of each of the first and second side guide plates such that a fixing pin is inserted into the fixing groove and a fixing pin fixing groove formed at one side of a blade fixing groove to fixedly mount the blade on an impeller.

2. The method of claim 1, wherein the protrusions of the shot moving plate and the insertion holes of the first and second side guide plates are formed in quadrilateral shapes.

3. The method of claim 1, further comprising a post-heating bending process of bending the shot moving plate to one side after the part cutting process.

4. The method of claim 3, further comprising a post-heating bending process of bending the first and second side guide plates to one side so as to match the first and second side guide plates to a shape of the bent shot moving plate.

5. The method of claim 1, further comprising a part grinding process after the part cutting process.

6. The method of claim 1, wherein all the steel plates which are used have the same thickness.

7. An impeller blade in an impeller of a shot peening machine in which a plurality of blade fixing grooves are formed in inner surfaces of two discs which face each other and the impeller blade is fixedly mounted on each of the blade fixing grooves, the impeller blade comprising:
a shot moving plate which is formed in a plate shape and in which one or more protrusions are formed on each of both side surfaces thereof; and
first and second side guide plates in which insertion holes are formed to be coupled and assembled with the protrusions of the shot moving plate,
wherein the first and second side guide plates are fixedly inserted into the blade fixing groove.

8. An impeller blade in an impeller of a shot peening machine in which a plurality of blade fixing grooves are formed in inner surfaces of two discs which face each other and the blade is fixedly mounted on each of the blade fixing grooves, the impeller blade comprising:
a shot moving plate and first and second side guide plates which are formed of a steel plate of a high carbon steel or high manganese steel material,
wherein two protrusions are formed to have a quadrilateral shape on each of both sides of the shot moving plate,
wherein fixing grooves are formed in the first and second side guide plates,
wherein two insertion holes having a quadrilateral shape are formed between the fixing groove and both ends of each of the first and second side guide plates such that the protrusions of the shot moving plate are inserted into the two insertion holes of each of the first and second side guide plates to assemble the first and second side guide plates to both side surfaces of the shot moving plate,
wherein the fixing groove is formed to be concavely recessed in a longitudinal center portion of each of the first and second side guide plates to fixedly mount the impeller blade on the impeller by inserting a fixing pin into the fixing groove and a fixing pin fixing groove formed in one side of the blade fixing groove, and
wherein a longitudinal center portion, along which a shot ball is moved, of the shot moving plate is bent in an outward direction.

9. The impeller blade of claim 8, wherein the first and second side guide plates are bent to match a shape of the bent shot moving plate.
